(19) United States
(12) Patent Application Publication
(10) Pub. No.: US 2006/0053213 A1
(43) Pub. Date: Mar. 9, 2006

(54) Method of handling web page requests from a browser

(76) Inventor: Robert Seeman, Vancouver (CA)

Correspondence Address: SYNNESTVEDT LECHNER & WOODBRIDGE LLP, P O BOX 592, PRINCETON, NJ, 08542-0592, US

(21) Appl. No.: 10/532,519

(22) PCT Filed: Oct. 30, 2003
(86) PCT No.: PCT/GB03/04668

§ 371 Date: Apr. 25, 2005

(30) Foreign Application Priority Data
Oct. 30, 2002 (GB) 0225241.9
Nov. 25, 2002 (GB) 0227359.7

(51) Int. Cl. G06F 15/16

(52) U.S. Cl. 709/218

(57) ABSTRACT

When an end-user enters a request for a web page directly into the URL line of a web browser, but erroneously mis-types the TLD as a country code TLD (e.g. typing ‘.co’ instead of ‘.com’), in place of a conventional error message being returned or browser defined default page, a web site with relevant information is returned.

### BACKGROUND OF THE INVENTION

1. Field of the Invention

This invention relates to a method of handling a request from a browser for a web page with a given TLD that an end-user has entered into the URL line of the browser.

2. Description of the Prior Art

Search engine results have grown so much that it is very difficult to find what you are searching for. Our research and experience shows that up to 25% of consumers type-in domain names directly into the browser Universal Resource Locator (URL) line to find what they are searching for instead of using the search engines. This may be a company that they are searching for, such as Microsoft.com, or a search for a product, service or information site, such as cars.com. For example, to cut though the excess of choice returned by search engines, some Web users, from time to time, avoid using search engines and simply add a “.com” or “.net” to the generic item they are looking for, i.e. “paper.com” or “paper.net”, and type it directly into the URL line in the web-browser. In this way, they are making a guess that they may be taken directly to a web site dedicated to what they are searching for, i.e. “paper”. If the web page does not exist, then an error message (e.g. “The specified server could not be found”) will be returned or a default page, set and requested by the browser, will be loaded. There are many reasons why an error of this sort may be returned: for example, the user may have mis-typed the name of a well known site, or used the incorrect top level domain (for example, instead of “paper.com”, typing in “paper.cm”.)

Advertisers are searching for more cost-effective ways of acquiring customers. Advertisers are looking for “targeted traffic”, defined as a consumer who is actively and consciously searching for a product, service or information source. Advertisers who are able to match this consumer need would then be able to target their advertisement to this consumer very effectively. Thus, advertisers are willing to spend money to advertise to their target market.

Commercialization of the Internet has led to billions of dollars being spent on Internet advertising and marketing each year. Originally, advertisers paid web site owners based on the number of times that a user was exposed to their advertisement. Advertisers now prefer to pay only if their banner is clicked on (“cost-per-click”) or a sale or service is purchased as a result of their advertisement (“cost-per-action”). Targeted traffic delivered to advertisers is important to maximise revenue on a cost-per-click or cost-per-action advertising revenue model.

### SUMMARY OF THE PRESENT INVENTION

The present invention is a method of handling a request from a browser for a web page with a given TLD that an end-user has entered into the browser URL line, comprising the steps of:
(a) determining whether the URL defines a web page that exists for that TLD;
(b) if it does not exist, then automatically providing for a domain name server to direct the browser to a different web site and not provide an error message or a browser defined default page;
   characterised in that the TLD has been erroneously entered by the end-user as a ccTLD instead of a TLD selected from the set of .com and .net TLDs.

The invention stems from the fact that Web users regularly make typographical errors. Specifically, they might mistype the “.com” or “.net” ending portion of the URL. There are many variations of mistyping this ending portion of the domain name, known at the Top Level Domain (TLD). However, this invention is especially useful for misspellings of TLDs which involve only one letter being accidentally omitted, resulting in a TLD that corresponds to Country Codes TLDs (ccTLDs). This includes (without limitation) “.cm”, “.om”, “.co”, “.ne” and “.et”. These top level domains correspond respectively to the ccTLDs of the countries of Cameroon, Oman, Colombia, Niger and Ethiopia. Currently, if, for example, a user types “paper.cm” into a web-browser and there is no site registered in that country code domain, the domain will not resolve and no web site will be retrieved and be viewable by the user on the Web-browser.

This invention permits the user to view a web site even when making one or more of the above typographical errors. This web site could be specifically related to the typed-in terms, or it could be a general search web site, portal, a web site containing advertising, or a combination.

The end-user is ‘targeted-traffic’ and hence of special interest to advertisers. By permitting the user to view a web site after such typographical errors, it is possible for advertising, transaction or other revenue to be earned for bringing the user to that web site. Databases record the relevant traffic to enable traffic based revenue to be calculated. Advertising, transaction or other revenue may also be earned if the user follows a link or performs a search on that web site or a directly or indirectly linked web site. Again, suitable databases track this activity to enable revenue to be calculated.

Implementation of this invention may require an agreement with at least one of the administrators of the ccTLD, such that all domains that would otherwise not resolve be directed to one or more specified servers. These servers would then return web sites containing e-commerce or other web-based services including advertising, such as the pay-per-click advertising offered by search engines and advertising services. The services offered or advertising may be partly or wholly ‘targeted’; e.g. for the paper.cm example, related in some way to paper. Or it may be party or wholly untargeted, i.e. having little or nothing to do with paper.

The present invention can guarantee the advertiser that it will have a prominent position to reach the targeted consumer, making the likelihood of a sales conversion greater. In contrast, it is very difficult to get listed on the first few pages for a keyword search on a search engine, such as Google or Yahoo. Since few people bother to look beyond the first few pages, this method of advertising through type-in domain names is very attractive to advertisers.

The present invention may in particular use domain names that are genetic search terms that have ccTLDs erroneously appended instead of a TLD like .com, resulting in type-in traffic that provides an ideal alternative method for such advertisers.

### DETAILED DESCRIPTION

The present invention will be described with reference to a system called ADit: the following section will describe the potential use of this system with the .co domain name, being the ccTLD for Colombia.

Colombia has an important asset that may capture a share of the targeted traffic market: the “.co” domain. The fact that “.co” differs from the “.com” domain by only one letter presents a very interesting opportunity to develop and take advantage of the concept of “targeted advertising traffic”.

The reason that “.co” is interesting is because “.co” is so dose to the most used top level domain, “.com”, where the bulk of the type-in traffic domain names resides.

We believe that a large number of people omit the “m” and this is potentially a very good opportunity for targeted, type-in traffic advertisements.

Further, Colombia does not commercialize the sale of “domain.co” which will give the Colombian Government and ADit, the possibility of receiving targeted, type-in traffic in every single word, in any language, and in every single mistyped word as long as the user mistypes “.com” as “.co”.

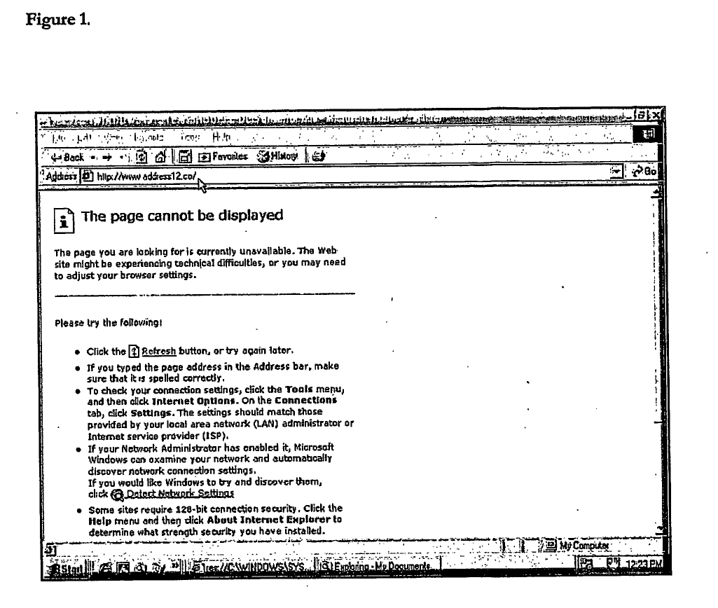

ADit proposes to use Internet web site requests that do not have valid addresses. For example, if an Internet user types ‘www.address12.co’ where ‘www.address12.co’ is not a registered domain name, that request would be directed to an ADit system web site at ‘www.webfile.com’. Today, users who type an invalid address generally receive an error message like the one in FIG. 1. The ADit system advertising page would replace these error messages.

We expect that there may be a large number of web site requests directed to the ADit system computer from people accidentally typing “.co” instead of “.com”.

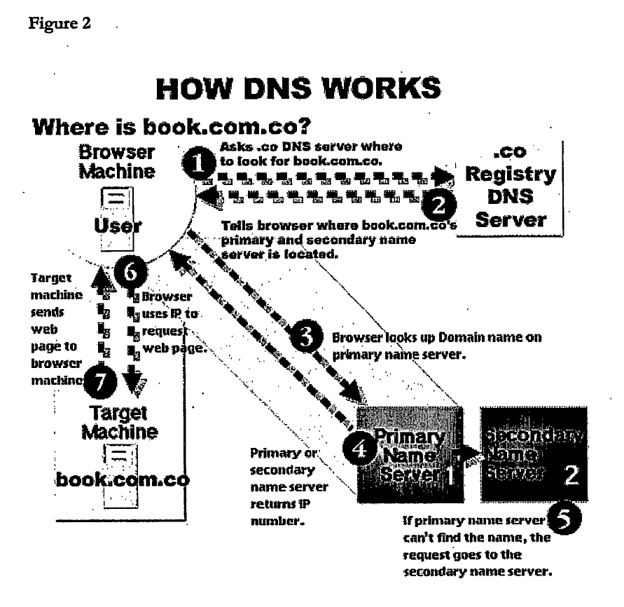

The Ministry of Communications of Colombia (the “Ministry”) currently has authority over the computer that holds the “.co Directory Assistance Service¹” (known as the Domain Name Server or “DNS”: it hosts the records needed to make a domain name point to the appropriate computer). Anytime a user anywhere in the world types in a web site name that ends in “.co”, e.g “book.com.co”, the person's computer automatically goes to the co DNS to try to obtain the unique identification number (IP) of the computer called “book.com.co”. This is much like a person telephoning directory assistance to obtain the telephone number of the person they wish to call. Assuming the domain book.com.co is registered, once the unique identification number of the web site's computer is received by the user's computer, the user's computer then directly requests the web page from the web site's computer. This entire process takes only a few seconds. FIG. 2 schematically illustrates it.

Today, when a request is made to the “.co” DNS for a domain name that is not registered, an error message is returned to the user. This is much like a person calling telephone directory assistance and being told that there is no telephone number listed for the person they wish to call.

We are proposing that, instead of an error message being returned when a web site is not registered, the unique identification number of the ADit system computer is returned to the requesting user's computer so that the person is then directed to the ADit system web site. There, they will find one of the ADit system optimized pages with links to products which ADit has selected to be as related as possible to the domain they are looking for. By a visitor clicking on any of the links available on the ADit system pages, Colombia and ADit will receive a predetermined fee from the company that placed that advertisement.

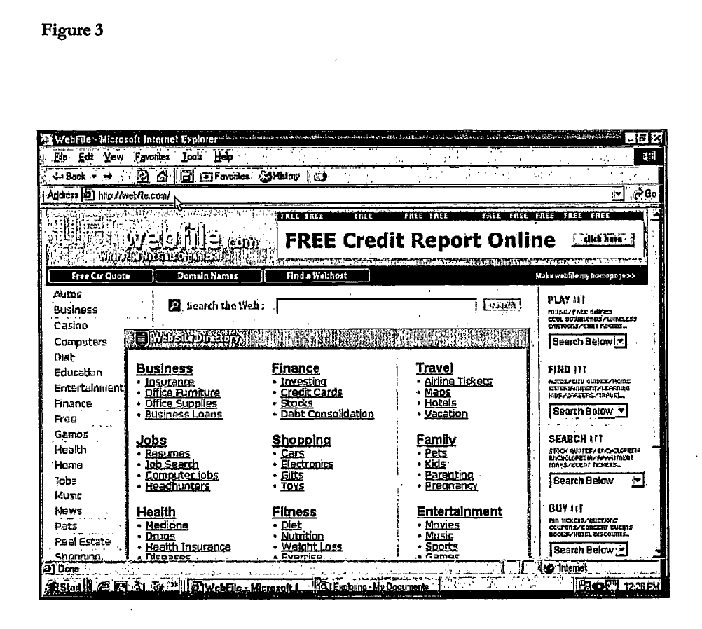

FIG. 3 shows what the user may see when redirected to the ADit system pages.

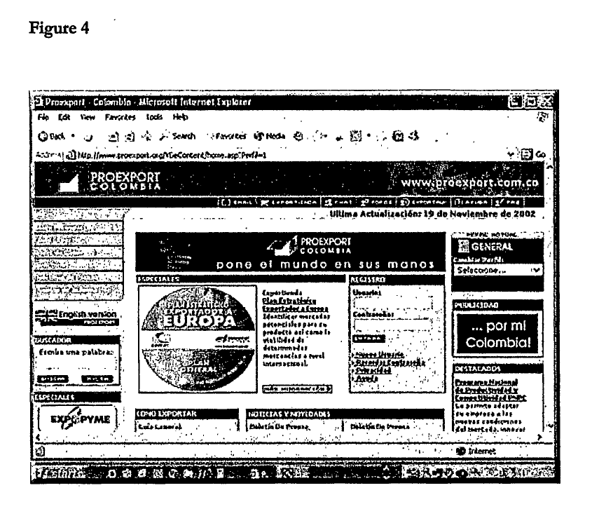

Colombia has a policy to increase the exposure of its exports. The ADit system can assist Colombia with such exposure, especially for South American users. ADit proposes a special portal, which will provide the opportunity to promote the international trade of Colombian goods and services. The Adit system can identify the geographic location of the user. Therefore, all users from South America could be directed to the Colombian trade portal, as shown in FIG. 4. For example, South American users who type “flowers.co” instead of “flowers.com” will be directed to the Colombian trade portal directly. A Venezuelan or Chilean who is looking for flowers.com, a non-Colombian business, may accidentally type in flowers.co and automatically be directed to the Colombian trade portal.

Furthermore, with the ADit system, it is possible to have optimized pages for the American and international markets, with extremely visible, specialized banner ads that include words for products that are in the export interests of Colombia and that will directly link to the Colombian Portal. i.e. flowers, coffee, lingerie, emeralds etc. When an American or International user types flowers.co, they will go to the ADit system page of links for this product but will see, in the most visible spot, a banner promoting Colombian flowers and when clicking the link they will be sent directly to the Colombian Portal page for flowers.

Establishment of the redirection to the ADit system computer by the Ministry is an extremely simple transparent technical change. The Ministry needs only to direct the administrator of the .co DNS server to add a simple computer instruction to the DNS computer program (zone file). The administrator would be able to thoroughly test the change before it becomes operational. The added computer instruction directs that: if the requested dot co domain name is not found in the list of registered names in the dot co DNS zone file, then the unique identification number (IP) of the ADit system computer is returned to the user's computer.

Based on the most popular open source DNS software, Bind version 9, the code to add to the DNS zone file on Colombia's DNS servers to redirect unregistered .co to ADit's servers would be as follows:
IN A 66.216.92.136

1. A method of handling a request from a browser for a web page with a given TLD that an end-user has entered into the browser URL line, comprising the steps of:
(a) determining whether the URL defines a web page that exists for that TLD;
(b) if it does not exist, then providing for a domain name server to automatically direct the browser to at least one web site and not provide an error message;
characterised in that the TLD has been erroneously entered by the end-user as a ccTLD instead of a TLD selected from the set of .com and .net TLDs.

2. The method of claim 1 in which the erroneous entry involves only one letter being accidentally omitted.

3. The method of claim 2 in which the ccTLD is selected from the set “.cm”, “.om”, “.co”, “.ne” and “.et”.

4. The method of claim 1 in which the web site is specifically related to the meaning of the URL.

5. The method of claim 1 in which the web site is a general web search site or portal.

6. The method of claim 1 in which the web site is one of several potential web sites the browser could be directed to, with the actual web-site selected depending on the geographic location of the end-user.

7. The method of claim 1 in which a database record is maintained of the traffic brought to the web site to enable traffic based revenue to be calculated.

8. The method of claim 1 in which a database record is maintained of the click-through traffic from the web site to enable click-through based revenue to be calculated.

9. The method of claim 1 in which the URL comprises a generic term.

10. The method of claim 1 in which a computer instruction is added to a DNS zone file to direct that if the requested domain name is not found in the list of registered names in the DNS zone file, then the unique identification number (IP) of a computer hosting the web site is returned to the end-user's computer.

11. A Domain Name Server (DNS) that handles a request from a browser for a web page with a given TLD that an end-user has erroneously entered into the browser URL line as a ccTLD instead of a TLD selected from the set of .com and .net TLDs, the DNS being programmed to:
(a) determine whether the URL defines a web page that exists for that TLD;
(b) if it does not exist, then automatically direct the browser to a web site and not provide an error message;
in which the DNS server is a ccTLD DNS.

12. The DNS of claim 11 in which the erroneous entry involves only one letter being accidentally omitted.

13. The DNS of claim 11 in which the ccTLD is selected from the set “.cm”, “.om”, “.co”, “.ne” and “.et”.

14. The DNS of claim 11 in which the web site is specifically related to the meaning of the URL.

15. The DNS of claim 11 in which the web site is a general web search site or portal.

16. The DNS of claim 11 in which the web site is one of several potential web sites the browser could be directed to, with the actual web-site selected depending on the geographic location of the end-user.

17. The DNS of claim 11 in which a database record is maintained of the traffic brought to the web site to enable traffic based revenue to be calculated.

18. The DNS of claim 11 in which a database record is maintained of the click-through traffic from the web site to enable click-through based revenue to be calculated.

19. The DNS of claim 11 in which the URL comprises a generic term.

20. The DNS of claim 11 in which a computer instruction is added to a DNS zone file to direct that if the requested domain name is not found in the list of registered names in the DNS zone file, then the unique identification number (IP) of a computer hosting the web site is returned to the end-user's computer.
